(19) United States
(12) Patent Application Publication
(10) Pub. No.: US 2003/0068027 A1
(43) Pub. Date: Apr. 10, 2003

(54) Methods, systems and computer program products for controlling access to communications systems using quotas

(76) Inventor: Uday Reddy Dodla, Cary, NC (US)

Correspondence Address: MYERS BIGEL SIBLEY & SAJOVEC, PO BOX 37428, RALEIGH, NC, 27627, US

(21) Appl. No.: 09/973,432

(22) Filed: Oct. 9, 2001

(51) Int. Cl. H04M 3/00

(52) U.S. Cl. 379/190

(57) ABSTRACT

A quota can be provided to a user that is registered with a communications system. The quota can authorize the user to place a call through the communications system when accessed from a remote area that is not serviced by the communications system until the quota is exhausted.

### FIELD OF THE INVENTION

The present invention relates to communication methods and systems in general, and more particularly, to methods and systems for controlling access to communications systems.

### BACKGROUND OF THE INVENTION

It is known to allow users outside an office to place calls in a fashion similar to how calls would be made from inside the office. For example, a remote user may log onto a system that allows the user to place calls through an office communications system. Unfortunately, non-authorized persons may access the office communications system and place calls if a username and password of an authorized user is stolen or otherwise obtained.

It is also known to issue calling cards, having a fixed length of time associated therewith, to allow access to a communications systems, such as the Public Switched Telephone Network (PSTN). The calling card can allow a user to make calls over the PSTN until the time allotment associated with the calling card is exhausted. The user can add more time to the calling card by purchasing an additional time allotment or may obtain an entirely new calling card with a new time allotment associated therewith.

### SUMMARY OF THE INVENTION

Embodiments according to the present invention can provide methods and systems for controlling access to a communications system using a quota. Pursuant to those embodiments, a quota can be provided to a user that is registered with a communications system. The quota can authorize the user to place calls through the communications system when accessed from a remote area that is not serviced by the communications system until the quota is exhausted.

### BRIEF DESCRIPTION OF THE DRAWINGS

FIG. 1 is a block diagram that illustrates systems and methods according to embodiments of the present invention.

FIGS. 2-5 are flowcharts that illustrate methods and systems according to embodiments of the present invention.

### DETAILED DESCRIPTION OF EMBODIMENTS ACCORDING TO THE INVENTION

The invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, the present invention may be embodied as methods and/or systems. Accordingly, the present invention may take the form of hardware embodiments, software embodiments or embodiments that combine software and hardware aspects.

The present invention is disclosed using flowchart illustrations and block diagrams. It will be understood that each block (of the flowchart illustrations and block diagrams), and combinations of blocks, can be implemented by computer program instructions. These program instructions may be provided to a processor circuit(s) within the system, such that the instructions which execute on the processor circuit(s) create means for implementing the functions specified in the block or blocks. The computer program instructions may be executed by the processor circuit(s) to cause a series of operational steps to be performed by the processor circuit(s) to produce a computer implemented process such that the instructions which execute on the processor circuit(s) provide steps for implementing the functions specified in the block or blocks.

Accordingly, the blocks support combinations of means for performing the specified functions, combinations of steps for performing the specified functions and program instructions for performing the specified functions. It will also be understood that each block, and combinations of blocks, can be implemented by special purpose hardware-based systems which perform the specified functions or steps, or combinations of special purpose hardware and computer instructions.

As used herein, the term “quota” is defined to mean an amount, such as a time for calls to be conducted, a cost of calls conducted, a number of calls to be placed, or any combination of time, cost, or number of the calls.

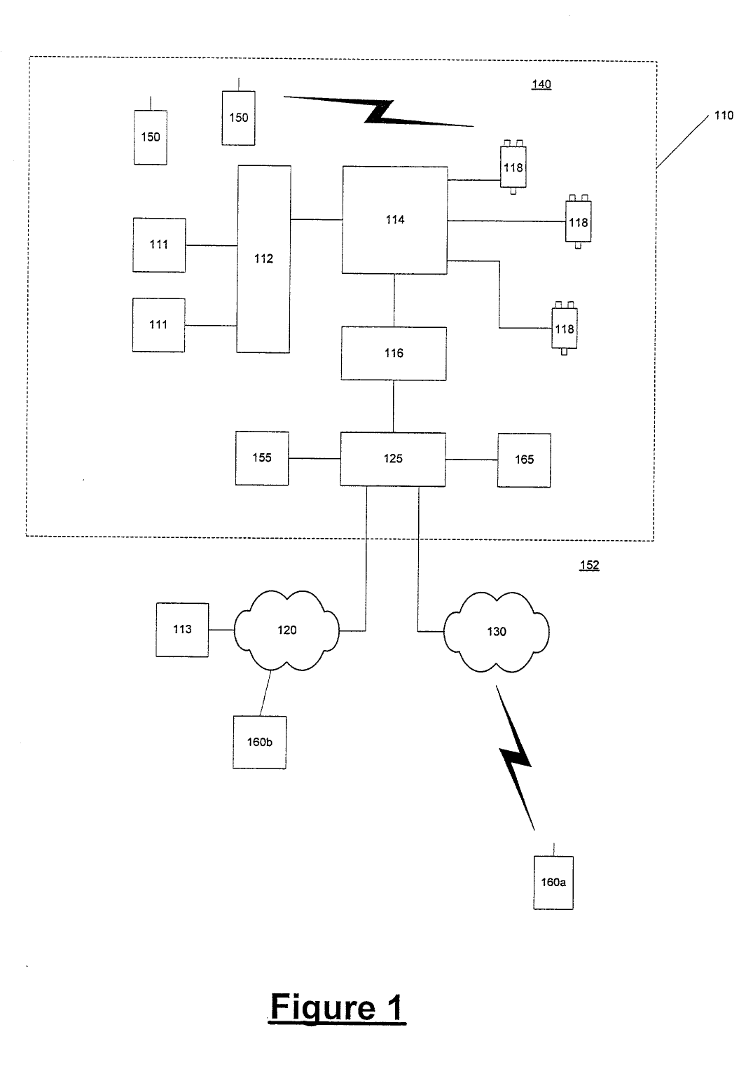

FIG. 1 is a block diagram that illustrates communications systems and methods according to embodiments of the present invention. According to FIG. 1, a communications system 110 provides service to a local area 140, such as an office site and/or an area adjacent to the office site. The communications system 110 provides service to wireless user terminals 150 and wireline user terminals 111. The communications system 110 does not provide service to a remote area 152 that is beyond the local area 140. The communications system 110 is configured to communicate with other communications systems. For example, as shown in FIG. 1, the communications system 110 communicates with a public cellular network 130 and a Public Switched Telephone Network (PSTN) 120. In some embodiments according to the present invention, the communications system 110 communicates with other types of communications systems.

The communications system 110 includes a plurality of transceivers (or radioheads) 118 that function in a manner similar to base stations in a cellular network. The radioheads 118 relay signals between the wireless user terminals 150 and a Cellular Radio Exchange (CRE) 114 that handles air interface and switching functions. The communications system 110 also includes a Private Branch Exchange (PBX) 112 that connects the CRE 114 to the wireline user terminals telephones 111.

A call by a user terminal within the local area 140 is typically initiated by transmitting a call origination message that identifies the number to which the call is directed. The origination message is received by one of the radioheads 118, and conveyed to other elements of the communications system 110 for authorization and placement of the call to its destination. For example, the wireless user terminal 150 can place a call to the wireline user terminal 111 through the radiohead 118/CRE 114/PBX 112. The wireless user terminal 150 can also place calls to a remote user terminal 160a in the remote area 152 through the communications system 110 and the PSTN 120 or to a remote user terminal 160b in the remote area 152 serviced by the cellular network 130.

A mobility server 116 provides access for remote user terminals 160a-b that are located in the remote area 152 outside the local area 140. The remote user terminals 160a-b access the mobility server 116 by logging into a personal assistant system 125 with which the remote user is registered. Once authorized by the personal assistant system 125, the remote user can use the remote user terminal to place calls through the communications system 110. For example, remote user terminal 160b can place calls to user terminals that are part of PSTN 120 by logging into the personal assistant system 125 and accessing the mobility server 116 which places the call to the user terminal 113 in the PSTN 120. Accordingly, the cost associated with the call placed to the user terminal 113 in the PSTN 120 from the remote area 152 can be allocated to the communications system 110 as if the call had been placed from the local area 140.

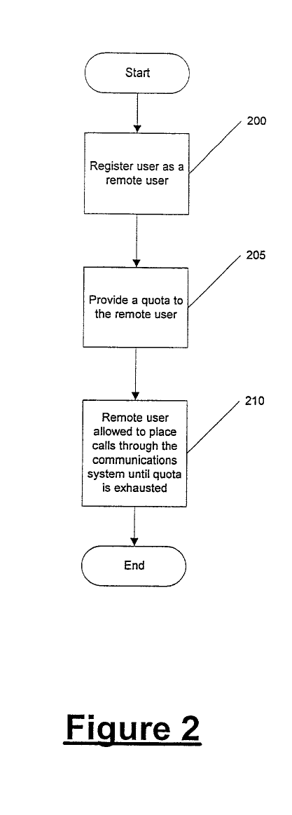

As shown in FIG. 2, in embodiments according to the present invention, a user can be registered with the communications system 110 as a remote user (block 200). A quota is associated with the registered remote user (block 205). The quota authorizes the remote user to place calls through the communications system 110 until the quota is exhausted. The remote user is authorized to place calls through the communications system 110 when accessed from the remote area 152 that is not serviced by the communications system until the quota is exhausted (block 210).

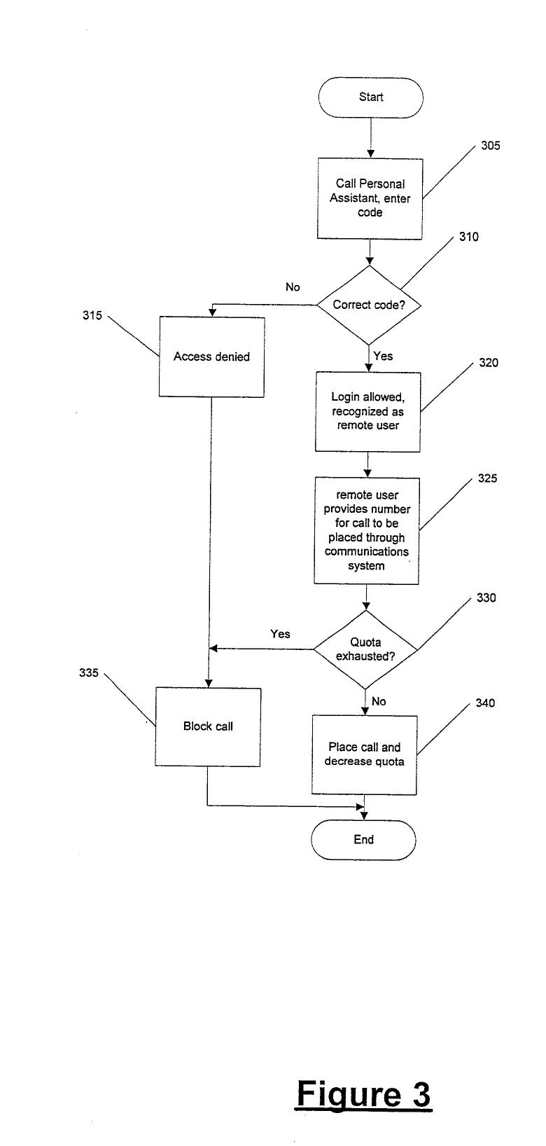

FIG. 3 is a flowchart that illustrates methods and systems according to embodiments of the present invention. In particular, a caller dials into the personal assistant using a predetermined telephone number and entering a code, such as a user name and password (block 305). If the code provided by the caller is incorrect (block 310) the caller is denied access to the communications system (block 315). If the code provided by the caller is correct (block 310), the caller is recognized as a remote user that is registered with the communications system (block 320). The remote user provides a number so that a call can be placed to that number through the communications system (block 325).

Upon receiving the request for the call to be placed (block 325), the communications system determines if the quota associated with the remote user is exhausted (block 330). In some embodiments according to the present invention, the quota is exhausted when the quota is equal to zero. In other embodiments according to the present invention, the quota is exhausted when the quota is equal to a number other than zero.

If the quota associated with the remote user is exhausted (block 330), the remote call is blocked (block 335). In some embodiments according to the present invention, even though the exhausted quota blocks the requested call, the remote user may use administrative functions provided by the communications system such as voice mail or call forwarding. In some embodiments according to the present invention, a call is not terminated if the quota of time is exhausted while a call is in progress. For example, if the quota of time is exhausted while the remote user is speaking to an administrator about increasing or replenishing the quota, the call will not be terminated. Rather, the call in progress can be completed even though the quota of time is exhausted.

If the quota associated with the remote user is not exhausted (block 330), the remote call is placed through the communications system and the quota is decreased to reflect placement of the call therethrough (block 340). In some embodiments according to the present invention, the quota is decreased by one to reflect the placed call. In some embodiments according to the present invention, the quota is reduced by a time to reflect a duration of the placed call. In some embodiments according to the present invention, an announcement is made to the remote user indicating the remaining quota available to the remote user for placing calls.

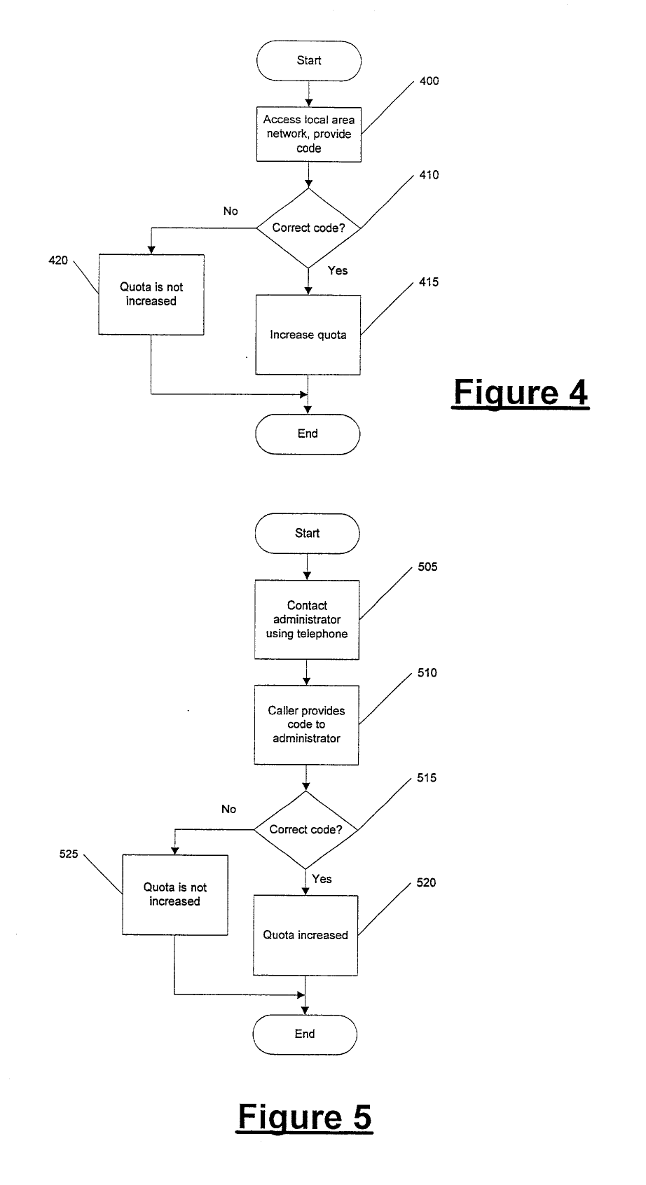

FIG. 4 is a flowchart that illustrates methods and systems according to embodiments of the present invention. In particular, a user logs into the personal assistant via a channel, such as a local network 155 (as shown in FIG. 1) associated with the communications system 110, using a code (block 405). The local network 155 can provide a secure environment in which the remote users can replenish their associated quotas for remote calls (block 400). If the code provided by the user is correct, (block 410) the user is recognized as a remote user and the quota is increased (block 415). If the code is not correct (block 410) the quota is not changed (block 420).

FIG. 5 is a flowchart that illustrates methods and systems according to embodiments of the present invention. In particular, a second channel, such as a telephone call, is used to contact a system administrator 165 or other individual or system that is authorized to replenish a quota (block 505). The caller provides the code, or other information, that can be used to authenticate the caller as a remote user (block 510). If the information provided by the caller is correct (block 515), the caller is recognized as a remote user and the system administrator 165 (as shown in FIG. 1) increases the quota associated with the remote user (block 520). If however, the information provided by the caller is not correct (block 515) the system administrator 165 does not change the quota (block 525).

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed:

1. A method of controlling access to a communications system by users comprising:
providing a quota associated with a user that is registered with a communications system that authorizes the user to place a call through the communications system when accessed from a remote area that is not serviced by the communications system until the quota is exhausted.

2. The method of claim 1 further comprising:
blocking the call when the communications system is accessed from the remote area and the quota is exhausted; and
allowing the call when the communications system is accessed from the remote and the quota is not exhausted.

3. The method of claim 1 wherein the quota comprises a number of calls.

4. The method of claim 1 wherein the quota comprises a time.

5. The method of claim 1 wherein the quota comprises a time and a number of calls.

6. The method of claim 1 wherein the quota comprises a number of calls, the method further comprising:
decreasing the quota responsive to allowing the call via the communications system when accessed from the remote area.

7. The method of claim 1 wherein the quota comprises a time, the method further comprising:
decreasing the quota by an amount of time associated with the call responsive to allowing the call via the communications system when accessed from the remote area.

8. The method of claim 1 further comprising:
allowing access to the communications system for purposes other than to place calls when the quota is exhausted.

9. The method of claim 1 wherein the access to the communications system from the remote area comprises access to the communications system over a first channel, the method further comprising:
allowing access to the communications system over a second channel; and
allowing the quota to be increased via a request over the second channel.

10. The method of claim 9 wherein act of allowing access to the communications system over a second channel comprises allowing access to the communications system via a local area network in the local area serviced by the communications system.

11. The method of claim 9 wherein act of allowing access to the communications system over a second channel comprises allowing an authorized user to increase the quota in response to a verbal request by the user.

12. A method of controlling access to a communications system by users comprising:
allowing a user that is registered with a communications system to access the communications system from a remote area that is not serviced by the communications system;
receiving a request from the user to place a call through the communications system;
determining whether a quota associated with the user that authorizes the user to place the call via the communications system from the remote area is exhausted;
blocking the call upon determining that the quota is exhausted;
allowing the call upon determining that the quota is not exhausted; and
decreasing the quota upon allowing the call to provide a reduced quota.

13. The method of claim 12 wherein the act of decreasing the quota upon allowing the call to provide a reduced quota further comprises: indicating the reduced quota to the user.

14. The method of claim 12 further comprising:
allowing access to the communications system via a local area network in the local area serviced by the communications system to increase the quota.

15. The method of claim 12 further comprising:
allowing an increase to the quota in response to a verbal request by the user.

16. A system for controlling access to a communications system by users comprising:
a processor circuit that is configured to allow a user that is registered with a communications system to access the communications system from a remote area that is not serviced by the communications system and that is configured to receive a request from the user to place a call through the communications system and that determines whether a quota associated with the user that authorizes the user to place the call via the communications system from the remote area is exhausted, and that is configured to block the call upon determining that the quota is exhausted; and that is configured to allow the call upon determining that the quota is not exhausted, and that is configured to decrease the quota upon allowing the call to provide a reduced quota.

17. The system of claim 16 wherein the processor is further configured to indicate the reduced quota to the user.

18. The system of claim 16 wherein the processor is further configured to allow access to the communications system via a local area network in the local area serviced by the communications system to increase the quota.

19. The system of claim 16 wherein the processor is further configured to allow an increase to the quota in response to a verbal request by the user.

20. A system for controlling access to a communications system by remote users comprising:
means for allowing a user that is registered with a communications system to access the communications system from a remote area that is not serviced by the communications system;
means for receiving a request from the user to place a call via the communications system;
means for determining whether a quota associated with the user that authorizes the user to place the call through the communications system from the remote area is exhausted;
means for blocking the call upon determining that the quota is exhausted;
means for allowing the call upon determining that the quota is not exhausted; and
means for decreasing the quota upon allowing the call to provide a reduced quota.

21. The system of claim 20 wherein the means for decreasing the quota upon allowing the call to provide a reduced quota further comprises:
means for indicating the reduced quota to the user.

22. The system of claim 20 further comprising:
means for allowing access to the communications system via a local area network in the local area serviced by the communications system to increase the quota.

23. The system of claim 20 further comprising:
means for allowing an increase to the quota in response to a verbal request by the user.

24. A computer program product for controlling access to a communications system by remote users, comprising:
a computer readable storage medium having computer-readable program code embodied in said medium, said computer-readable program code comprising:
computer-readable program code for allowing a user that is registered with a communications system to access the communications system from a remote area that is not serviced by the communications system;
computer-readable program code for receiving a request from the user to place a call through the communications system;
computer-readable program code for determining whether a quota associated with the user that authorizes the user to place the call via the communications system from the remote area is exhausted;
computer-readable program code for blocking the call upon determining that the quota is exhausted;
computer-readable program code for allowing the call upon determining that the quota is not exhausted; and
computer-readable program code for decreasing the quota upon allowing the call to provide a reduced quota.

25. The computer program product of claim 24 wherein the computer program code for decreasing the quota upon allowing the call to provide a reduced quota further comprises:
computer-readable program code for indicating the reduced quota to the user.

26. The computer program product of claim 24 further comprising:
computer-readable program code for allowing access to the communications system via a local area network in the local area serviced by the communications system to increase the quota.

27. The computer program product of claim 24 further comprising:
computer-readable program code for allowing an increase to the quota in response to a verbal request by the user.
